(19) United States
(12) Patent Application Publication
(10) Pub. No.: US 2017/0046968 A1
(43) Pub. Date: Feb. 16, 2017

(54) FLIGHT SIMULATION MODELING OF AIRCRAFT DYNAMIC STALL AERODYNAMICS

(71) Applicant: The Boeing Company, Chicago, IL (US)

(72) Inventors: William Gato, Maple Valley, WA (US); Luis-Alberto Santiago, Shoreline, WA (US); David Andrew Shikany, Issaquah, WA (US)

(21) Appl. No.: 14/823,507

(22) Filed: Aug. 11, 2015

(51) Int. Cl. G09B 9/20; G06F 17/50

(52) U.S. Cl. CPC G09B 9/206; G06F 17/5009

(57) ABSTRACT

Flight simulation models are described that have one or more model components that are based on angle-of-attack (AOA) rate. An example method includes monitoring a behavior of a simulated aircraft in a flight simulation, determining an AOA rate of the aircraft during a simulated dynamic stall maneuver, determining a value for a model component based on the determined AOA rate and simulating a first aerodynamic effect on the behavior of the aircraft during the simulated dynamic stall maneuver based on the value of the model component.

### STATEMENT REGARDING FEDERALLY SPONSORED RESEARCH OR DEVELOPMENT

This disclosure was made with Government support under Contract No. DTFACT 11-80002 awarded by the United States Department of Transportation Federal Aviation Administration. The Government of the United States may have certain rights in this disclosure.

### FIELD

The present disclosure relates generally to flight simulation modeling and, more particularly, to flight simulation modeling of aircraft dynamic stall aerodynamics.

### BACKGROUND

Flight simulators artificially recreate aircraft flight and the environment in which an aircraft flies. Flight simulators are used for many purposes such as for training pilots (and crew members), for design and development, and for research. To simulate or model the real world effects of aerodynamic behavior, flight simulators use equations of the aerodynamics and other model components to simulate how an aircraft flies, how an aircraft responds to certain flight controls, and how an aircraft reacts to external factors.

### SUMMARY

An example method disclosed herein includes monitoring, via a processor, a behavior of a simulated aircraft in a flight simulation and determining, via the processor, an angle-of-attack rate of the aircraft during a simulated dynamic stall maneuver. The example method also includes determining, via the processor, a first value for a first model component based on the determined angle-of-attack rate and simulating, via the flight simulation, a first aerodynamic effect on the behavior of the aircraft during the simulated dynamic stall maneuver based on the first value of the first model.

An example system disclosed herein includes a flight simulator to simulate an aircraft and a behavior of the aircraft during a dynamic stall maneuver. The example system also includes a processor to determine an angle-of-attack rate of the simulated aircraft during the dynamic stall maneuver, determine a first value for a first model component based on the determined angle-of-attack rate, and input the first value for the first model component into the flight simulator to simulate a first aerodynamic effect on the behavior of the aircraft during the dynamic stall maneuver.

Disclosed herein is an example tangible machine readable storage medium having instructions that, when executed, cause a machine to at least monitor a behavior of a simulated aircraft in a flight simulation, determine an angle-of-attack rate of the simulated aircraft during a simulated dynamic stall maneuver, determine a first value of a first model component based on the determined angle-of-attack rate and simulate a first aerodynamic effect on the behavior of the aircraft during the simulated dynamic stall maneuver based on the first value of the first model component.

The features, functions and advantages that have been discussed can be achieved independently in various examples or may be combined in yet other examples, further details of which can be seen with reference to the following description and drawings.

### BRIEF DESCRIPTION OF THE DRAWINGS

FIG. 1 illustrates a three-dimensional system used to define the orientation of an aircraft.

FIG. 2 shows a static lift curve depicting lift versus angle of attack.

FIG. 3 shows the static lift curve of FIG. 2 depicting the hysteresis associated with a relatively slow stall entry and a relatively fast stall recovery.

FIG. 4 shows the results of a plurality of flight tests and a known flight simulator model curve plotted as the coefficient of lift versus the angle of attack of the body.

FIG. 5 shows another static lift curve using a known hysteresis model.

FIG. 6 shows the plot of FIG. 4 with the known flight simulator model adjusted with a lift correction component using the known hysteresis model of FIG. 5.

FIG. 7 shows the results of a plurality of forced-oscillation tests performed at two different rates and at a zero rate (static tests).

FIG. 8 illustrates an example flight simulating modeling system that may be used to implement flight simulation in accordance with the teachings of this disclosure.

FIG. 9 is a flowchart representative of an example method that may be performed by the example flight simulation modeling system of FIG. 8.

FIG. 10 is a diagram of a processor platform for use with the examples disclosed herein.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

### DESCRIPTION

Flight simulation is used throughout the aviation industry for training pilots and crew members, for design and development of aircraft, for research, and for training maintenance engineers in aircraft systems. To simulate aircraft flight, flight simulators employ aerodynamic models to predict the behavior of the simulated aircraft based on one or more model components. In general, pilots are trained, via a flight simulator, about the effects of an approaching aerodynamic stall and how to avoid entering such a stall. An aerodynamic stall occurs when the flow of air over an airfoil (e.g., an aircraft wing), which is at an angle to the flow of air (referred to as angle of attack), separates from the leeward surface (e.g., the upper surface for leading-edge-up or positive angle of attack) of the airfoil, thereby causing a reduction in the lift generated by the airfoil. The stall angle of attack is the angle at which the generated lift reaches a local maximum value. At that point, the generated lift typically decreases or levels off thereafter with a further increase in angle of attack. Aircraft stalls may occur under quasi-static conditions where the angle of attack increases slowly until the stall angle of attack is reached. The recovery from a stall, however, is generally more dynamic with angle of attack decreasing rapidly as the aircraft pitches down in the recovery maneuver. There has been recent interest in flight simulation for training pilots and crew in stall recognition and recovery from a stall (e.g., a full stall) to enhance safety. Specifically, in recent years, there has been greater emphasis on the stall recovery aspects and, therefore, the benefit of increased fidelity, accuracy and performance in flight simulation training in this regime. This interest has led to the realization that modeling the recovery from a stall, in particular, should include the dynamic aspects of flow reattachment on the upper surface of the wing during the typically fast recovery maneuver.

Dynamic stall occurs when an airfoil moves through and beyond its static stall angle of attack while experiencing a rapid increase in angle of attack. Dynamic stall-flow reattachment is the counterpart of dynamic stall that occurs when the airfoil, having moved through and beyond its static stall angle of attack, experiences a rapid decrease in angle of attack. Dynamic stall-flow reattachment in a relatively fast stall recovery produces an effect known as stall hysteresis, where the lift of an aircraft (e.g., which is generated primarily by the wings) during a relatively slow stall entry is different than the lift generated, passing through the same angles of attack, during a relatively fast stall recovery. Stall hysteresis is also experienced in the pitching moment and drag of the aircraft. In known flight simulation models, dynamic stall-flow reattachment is modeled through various means that affect the lift and pitching moment in the simulation model with drag effects generally being ignored. In particular, known flight simulation models use a static curve (for each of the above model components) and adjust the static curve to simulate the hysteresis effect during the stall recovery by either adding an incremental correction or modeling the effect as an incremental function of the pitch rate. However, the fidelity of the latter in the known flight simulation models is reduced because the model does not properly account for (e.g., does not fully represent) the dynamic stall effects (e.g., as occurs in turning stalls). Neither of the two known simulation methods properly models the physics of the stall scenario; the former has no rate dependency and the latter has pitch-rate dependency, which is only accurate when both pitch rate and angle-of-attack rate are substantially the same in either the stall entry or the stall recovery. During a wings-level stall, pitch and angle-of-attack rates are nearly identical both in the stall entry and in the recovery. However, during a turning stall, pitch and angle-of-attack rates are significantly different in the stall entry. As such, modeling the stall hysteresis effect as a function of pitch rate introduces an error in the stall entry lift and pitching moment models.

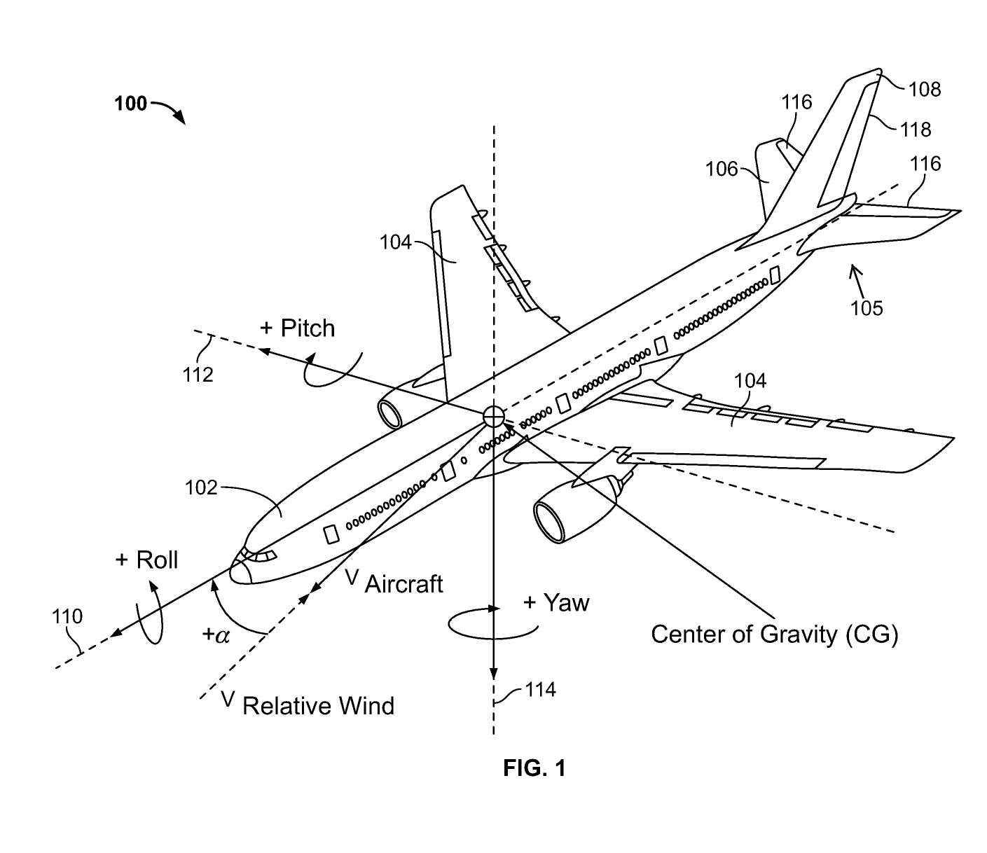

Disclosed herein are example flight simulation models that use angle of attack (referred to as AOA, AoA or α) and angle-of-attack rate (referred to as alpha-dot or “\dot{α}”, and in its non-dimensional form as alpha-dot-hat or “\dot{α}” with a hat “A” over it) to more accurately model the aerodynamics of dynamic stall in an atypical fast stall entry (e.g., non-typical, where stall entry is typically relatively slow) and dynamic stall-flow reattachment in the typically fast stall recovery. In aerodynamics, AOA is the angle between the oncoming air or relative wind and a reference line (e.g., a chord) of the airfoil (e.g., a wing of an aircraft and/or other horizontal lifting surfaces), and AOA rate or \dot{α} is the change of AOA over time. In some examples, the reference line is a line connecting the leading edge and trailing edge at some average point on a wing (e.g., the mean aerodynamic chord (MAC) of a wing) or a reference fuselage line either parallel to or at an angle (e.g., wing incidence angle) to the wing reference line. The latter case is illustrated in FIG. 1 and it is the angle of attack (referred to as body angle of attack) that is used in known aerodynamic simulation models.

In general, example systems and methods are disclosed that use the example flight simulation models to calculate model components such as lift, pitching moment, and/or drag, based on AOA rate (and not pitch rate, as is the case in one of the known flight simulation models). In particular, the example flight simulation models use AOA rate as an independent variable, in addition to AOA and other independent variables such as flap deflection, in determining the values of model components. Although in many instances the AOA rate is substantially the same as the pitch rate, in other instances the AOA rate is significantly different than the pitch rate. For example, the AOA rate may be different from the pitch rate when there are upward or downward wind gusts or in plunging motion, which are examples of vertical relative flow acceleration or unsteady flow. In either of these cases the aircraft's pitch rate may be nearly zero while the aircraft's AOA rate may be significant. Another example is during the entry portion in a turning stall where the aircraft is pitching through the air in a curved flight path at a given pitch rate while AOA is increasing at a significantly lower rate as the stall AOA is reached. As a result, the disclosed simulation models produce a higher fidelity (e.g., more accurate) modeling of the aerodynamic behavior of an aircraft not only in the stall entry and the recovery of either wings-level or turning stalls, but also under any aerodynamic wing-stall scenario where there are differences between pitch rate and AOA rate.

Additionally or alternatively, in some examples AOA rate may be used to calculate other model components such as the force and moment components of control-effectiveness model components of the various wing and tail control surfaces and/or the force and moment components of static- and dynamic-stability model components related to the wing and tail surfaces. The model components related to the tail surfaces are affected differently by the wing wake in a more dynamic stall and the typically dynamic stall recovery as compared to their quasi-static or low-rate counterparts. For example, the AOA rate may be used to affect model components such as roll due to sideslip, roll due to roll rate, aileron and spoiler roll control effectiveness, stabilizer and elevator pitch control effectiveness, rudder effectiveness and/or any other model component used in flight simulation.

Before describing detailed examples that employ the teachings herein, a brief description of stall modeling is provided. In general, while in flight, an aircraft rotates about its center of gravity (CG). A three-dimensional coordinate system is defined through the center of gravity with each axis of this coordinate system perpendicular to the other two axes. The orientation of the aircraft relative to the wind and/or to the earth can be defined by the amount of rotation of the aircraft along the three principal axes, chosen as to facilitate the simulation modeling. For example, the body axes of an aircraft 100 are illustrated in FIG. 1, where the aircraft 100 includes a body or fuselage 102, wings 104 that are coupled to the fuselage 102 and a tail 105 (e.g., an empennage) that includes a horizontal stabilizer 106 and a vertical stabilizer 108, which are both attached to the rear of the fuselage 102. The aircraft 100 can rotate about three axes, namely, a longitudinal x-axis 110, which extends along the fuselage 102 of the aircraft 100, a lateral y-axis 112, which extends along to the span of the wings 104 and is perpendicular to the longitudinal x-axis 110, and a vertical or directional z-axis 114, which is perpendicular to both the longitudinal x-axis 110 and the lateral y-axis 112. Roll, pitch and yaw refer to rotations of the aircraft 100 about the respective axes 110, 112, 114 starting from a defined steady state or flight equilibrium. For example, pitch refers to the rotation (nose up or down) of the aircraft 100 about the lateral y-axis 112, roll refers to the rotation of the aircraft 100 about the longitudinal x-axis 110, and yaw refers to the rotation of the aircraft 100 about the vertical or directional z-axis 114.

In general, lift is a force that is generated by the aircraft wings 104. Lift is perpendicular to the direction of the air flow (e.g., flow of fluid), while drag is the force in the direction of the air flow. In FIG. 1 the direction of the air flow is indicated by an arrow referred to as V_{relative wind}, which is equal and opposite to the direction of flight of the aircraft 100 through the air indicated by an arrow referred to as V_{aircraft}. The wings 104 of the aircraft 100 have high-lift devices or surfaces (e.g., flaps, slats, etc.) which are located along the leading and trailing edges and control surfaces which are located generally along the trailing edges (e.g., ailerons and flaperons) or on the upper surface (e.g. spoilers) of the wings 104. The high-lift device and/or control surfaces may be displaced or adjusted (e.g., angled, rotated, deployed, deflected, etc.) to change lift (e.g., for takeoff and landing and for maneuvering). Changing the inclination of the wings 104 or of the high-lift devices and control surfaces (e.g., the angle of the wings 104 relative to the oncoming airflow, or the deflection of the flaps, spoilers or ailerons relative to each wing) changes the amount of lift that the wings 104 generate. This, in turn, causes the aircraft 100 to have more or less lift as required in a climb, descent, or turn. In the case of ailerons and spoilers that are angled or deflected different amounts on the right and left wings 104 or on one wing only, the change in angle or deflection causes differences in lift between the right and left wings 104, which cause the aircraft 100 to roll.

Pitching moment results from a vertical force (e.g., perpendicular to the longitudinal x-axis 110 and parallel to the vertical or directional z-axis 114) applied at a distance forward or aft from the center of gravity, causing an aircraft to pitch up or down (e.g., rotate about the lateral y-axis 112). At the rear of the fuselage 102 is the horizontal stabilizer 106, which prevents pitching up or down motion of the nose of the aircraft 100 about the lateral y-axis 112 by generating a vertical force that opposes this motion. The horizontal stabilizer 106 is used to balance the aircraft 100 in pitch (e.g., trim the aircraft 100) at a desired AOA and, once fixed at that deflection, the trim deflection, prevents the aircraft 100 from pitching away from the trim AOA, as described herein. The horizontal stabilizer 106 includes elevators 116, which are moving surfaces that are attached to the rear of the horizontal stabilizer 106 via hinges. The elevators 116 deflect or rotate about a hinge line to vary the amount of force generated by the horizontal stabilizer 106 and are used to control the pitch motion of the aircraft 100. The change in vertical force generated by deflecting the elevators 116 generates a torque or pitching moment about the center of gravity, which causes the aircraft 100 to rotate in pitch about the lateral y-axis 112 and, thus, change the AOA of the aircraft 100 and the wings 104 to change the total of lift of the aircraft 100. Additionally, the elevators 116 are used to control the position of the nose of the aircraft 100. During take-off, the elevators 116 are used to bring the nose of the aircraft 100 up to begin the climb out. During a banked turn, an up input to the elevators 114 increases lift by changing the AOA of the wings 104. In a banked turn, the lift of the wing 104 is increased to both carry the weight of the aircraft 100 and provide the force that causes the turn. The vertical stabilizer 108 and rudder 118 play a similar role in stabilizing and controlling the aircraft 100 by generating a side force parallel to the lateral y-axis 112 and aft of the CG in the illustrated case to generate a yawing about the vertical or directional z-axis 114.

Lift, drag and pitching moment are three model components (e.g., the three longitudinal components of six aerodynamic force and moment components) used in flight simulation to reproduce the aerodynamics of the longitudinal behavior of an aircraft. The longitudinal behavior of an aircraft may be defined by the translational and rotational motion in the plane defined by the intersection of, or wherein lie, both the longitudinal x-axis 110 and the vertical or directional z-axis 114, referred to as the plane of symmetry of the aircraft. In known flight simulation models, the lift, drag and pitching moment components are generally calculated based on AOA; the deflection of the high-lift devices and control surfaces; and pitch rate, which is the rate of change of pitch about the lateral axis 112. In particular, these model components are calculated based on static flow models (e.g., representative of steady flow that occur after the airflow has stabilized at an angle to the model, namely AOA) and dynamic flow models representative of steady rotation about axes 110, 112, or 114, or a similarly orthogonal axes system rotated about the lateral y-axis 112 such that the longitudinal x-axis 110 is aligned with the relative wind or velocity vector of the aircraft 100 as illustrated in FIG. 1, where the velocity vector lies in the plane of symmetry of the aircraft 100. The known dynamic flow models, while incorporating pitch rate, are generally applicable to the well-behaved, linear aerodynamics at angles of attack significantly lower than the stall AOA. However, dynamic stall and dynamic stall-flow reattachment, being nonlinear unsteady aerodynamic effects that occur when airfoils or wings rapidly change AOA, are not modeled well by these linear dynamic models. The known flight simulation models are unable to accurately capture these dynamic effects under differing stall scenarios across the pitch-rate and AOA-rate spectrums. The known flight simulation models introduce a dynamic element through pitch rate to adjust the values of the static lift and pitching moment (i.e., under static, steady state flow conditions) in an attempt to more accurately model stall hysteresis (discussed in further detail herein). However, this approach does not account for the various aerodynamic effects experienced by an aircraft during different stall types and, thus, modeling the aerodynamic components to account for these effects based on pitch rate alone does not accurately capture the value of these components for all stall types such as, for example, in stall scenarios where pitch and AOA rates may be significantly different.

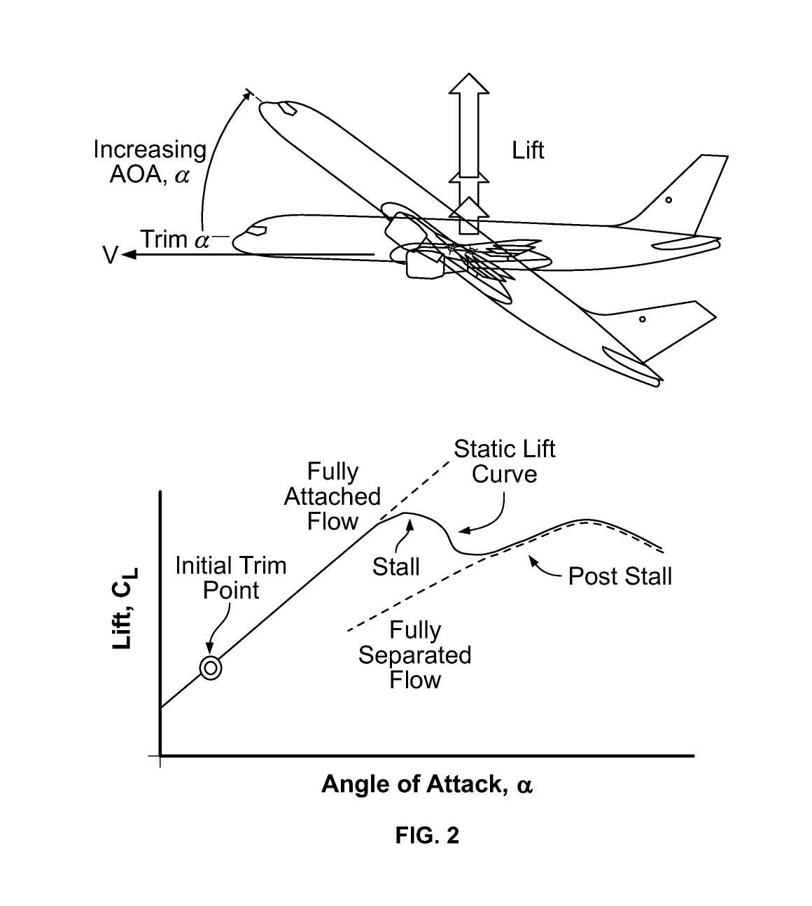

At relatively low speeds, lift is mainly a function of AOA and is generated primarily by the action of the airflow over both the upper and lower surface of the wings. Lift increases linearly with AOA until the airflow starts to separate from the upper surface of the wings. At this point lift still increases, but at an increasingly lower value per degree of AOA (e.g., lessening lift-curve slope) until it reaches a maximum and then starts decreasing as the airflow fully separates from the upper surface of the wings. Once the upper surface flow is fully separated, lift is generated primarily by the flow-turning action of the lower surface of the wings. FIG. 2 illustrates a plot of a static lift curve, which is the basis in known flight simulation models of the lift model component. The relationship between lift and increasing AOA is depicted, highlighting the difference between lift generated with fully-attached flow, lift generated with fully-separated flow, and the transition that occurs through the stall. The ‘X’ axis of the plot is the AOA, designated as a, and the ‘Y’ axis of the plot is the coefficient of lift, designated as C_{L}. At a low AOA, the airflow over the upper and lower surface of the wings is smooth and uniform at the initial trim point in FIG. 2, for example.

As AOA approaches the stall AOA, the airflow over the upper surface of the wings starts to separate with lift reaching a maximum at the stall point noted in FIG. 2. Beyond this point, the airflow continues to separate across the entire upper surface of the wings and lift decreases and follows a different variation with AOA, where the upper surface of the wings contributes much less to the total lift generated by the wings. In other words, lift increases with AOA up to the stall point, beyond which lift decreases. In some instances, lift may level off as the airflow over the upper surface of the wings transitions from partially separated to fully separated flow. At a post-stall point beyond the transition region, the airflow is fully separated from the upper surface of the wings and follows a different lift variation, increasing again, but at a lower rate with increasing AOA than that of the fully attached flow as indicated by the respective dashed curves in FIG. 2.

When AOA is slowly increased and then slowly decreased through the stall angle-of-attack range, the lift generated, which is referred to as static lift, follows the same path on the lift curve shown, namely the static lift curve. Static lift is measured when the airflow stabilizes and remains steady. However, if the AOA is decreased at a faster rate through the stall as in a typical stall-recovery, dynamic stall-flow reattachment occurs. In general, dynamic stall and dynamic stall-flow reattachment are nonlinear, unsteady aerodynamic effects that occur when airfoils or wings rapidly change AOA. In a dynamic stall entry, the rapid increase in AOA causes a vortex to form on the leading edge of the airfoil, which then travels downstream over the wing upper surface delaying flow separation to a higher AOA. This vortex and the delayed flow separation increases the lift produced by the wings under steady or static flow conditions. Typically, the rate of AOA increase in the stall entry is low and the dynamic-stall effect does not occur, or is minimal, so that the lift generated approximately follows the static lift curve depicted in FIG. 2. On the other hand, recovery from a stall is typically faster and more dynamic so that the rate of AOA decrease is high and the unsteady nature of the flow is such that reattachment of the separated flow is delayed and occurs at significantly lower angles of attack than under static flow conditions. As a result, there is significantly lower lift experienced during the stall recovery as compared to the stall entry across the same AOA range. This apparent two-path effect is referred to as stall hysteresis (e.g., different transition paths between fully-attached and fully-separated flow lift for the slow stall entry compared to the relatively fast stall recovery). The pitching moment and drag model components also exhibit a similar stall hysteresis effect. In other words, there are two different paths or characteristic curves for each of the lift, pitching moment and drag components, where one of the curves corresponds to the stall entry and the other corresponds to the stall recovery.

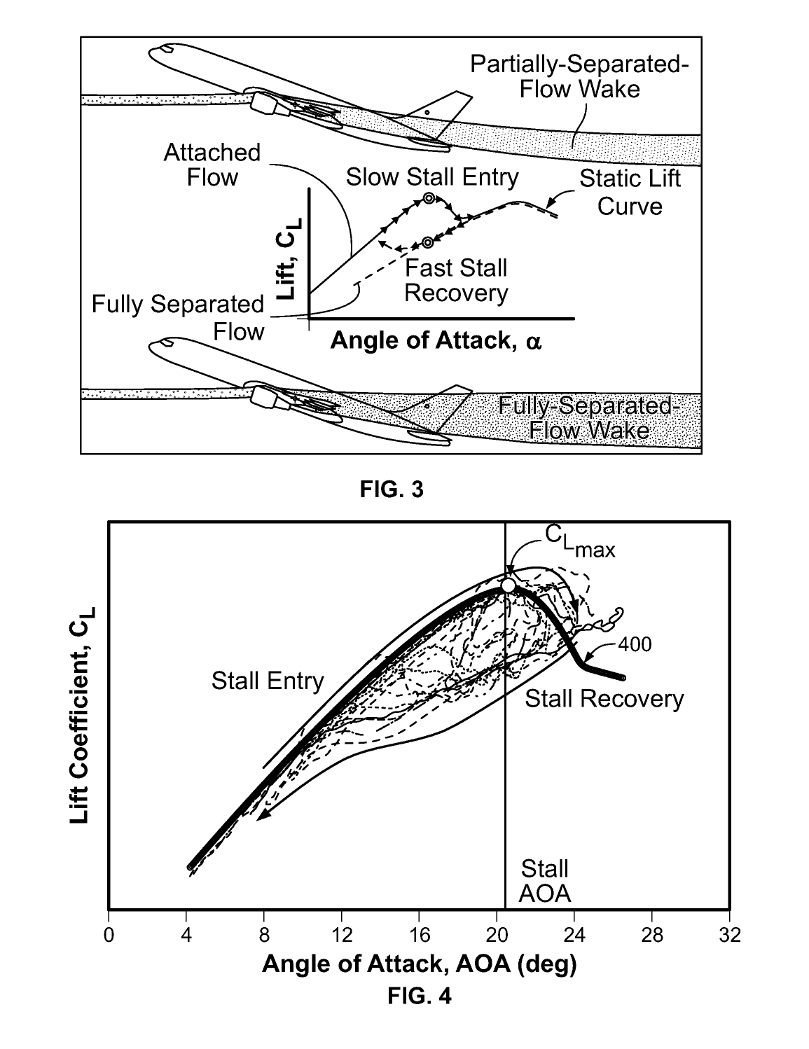

FIG. 3 shows stall hysteresis occurring in a lift curve. The upper path or curve illustrates the lift generated during a stall entry (e.g., while AOA is slowly increasing) and the lower path or curve illustrates the lift generated while performing a stall recovery maneuver (e.g., while the AOA is rapidly decreasing). As illustrated, the stall recovery path does not follow the same path as the stall entry. In both paths, the same angles of attack are experienced. However, the coefficient of lift, C_{L}, is lower for the stall recovery than for the stall entry at any given AOA across a wide range. In other words, the coefficient of lift, C_{L}, can be different for the same AOA depending on whether the aircraft is experiencing a slow stall entry or a fast stall recovery. This two path effect is linked to different levels of flow separation at the same angle of attack during the slow stall entry as compared to the fast stall recovery, with different wake geometry and wake-flow energy associated with the differences in flow separation at the same angle of attack. The upper aircraft image in FIG. 3 illustrates the flow separation occurring during stall entry at the stall AOA, which correlates to the portion of the curve labeled ‘Slow Stall Entry’, and the lower aircraft image illustrates the flow separation occurring during stall recovery at the same AOA, which correlates to the portion of the curve labeled ‘Fast Stall Recovery’.

This same two-path effect is also present in the pitching moment and drag model components. Also, it is found that at the same AOA, the relative location (low vs. high) and character (partially separated and higher energy as opposed to fully separated and lower energy) of the stall-entry and stall-recovery wakes affect the contribution to pitching moment of the horizontal stabilizer 106 differently. In some known flight simulation models, the tail force and moment components are modeled as incremental effects on the corresponding tailless basic components. In such models, the tail components (e.g., the horizontal stabilizer 106 and the vertical stabilizer 108) are in turn affected by wing-wake components (wake-flow energy content) and wing-downwash components (wake-flow angle relative to the free stream). The differences between stall entry and stall recovery lift, drag and pitching moment are associated with the differences in the dynamic transition between fully-attached and fully-separated flow and the associated difference in the stalled wing wake. Known simulation model buildup of aerodynamic model components (e.g., lift, pitching moment and drag, etc.) is separated into a static basis, or a basic component, to which a dynamic incremental component is added. The former is based on wind-tunnel and flight-test data gathered under static conditions. The latter is based on analytically derived dynamic derivatives that fail to capture the nonlinear, unsteady aerodynamics of the stall recovery in particular. Therefore, known modeling techniques adequately reproduce only the slow stall entry flight data.

FIG. 4 illustrates a plot of the coefficient of lift, C_{L}, versus AOA relative to the body-reference line of the aircraft. A plurality of tests from actual flight stalls are shown in the plot where the error between simulated lift and flight lift has been added to the basic lift component of a known flight simulation model to generate an estimate of the actual flight lift. The basic lift curve in this model is labeled as 400. As can be seen, there is a consistently lower actual lift level experienced during the typically fast stall recovery maneuvers as compared to the typically slow stall entry maneuvers. The basic lift curve 400 substantially matches the curves of the flight test data during the slow stall entry. However, it is clear that there is a need to account for the difference in lift that occurs during the relatively faster stall recovery, because the dynamic modeling does not capture the dynamic stall-flow reattachment aerodynamics (e.g., because the known flight simulation model has only one lift path or curve). In an attempt to remedy this inconsistency, some known simulation models incorporate a stall hysteresis correction term or component (e.g., an error term). This separate stall hysteresis component determines which portion of the stall maneuver is being simulated (e.g., stall entry v. stall recovery) and then only corrects the lift in the stall recovery portion to simulate an average lower-level without regard to how fast is the stall recovery maneuver executed.

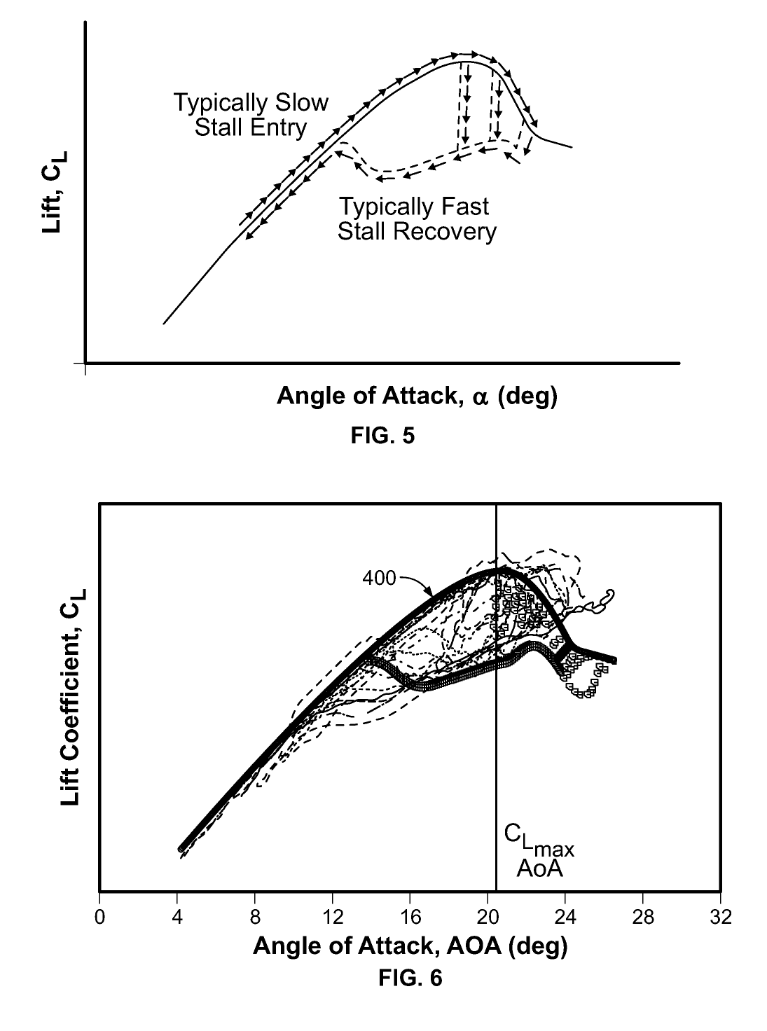

FIG. 5 illustrates known stall hysteresis modeling of the lift component in such known flight simulation models. In general, the hysteresis model component includes a table of lift increments that when added to the basic lift curve model component defines an average of the lower lift levels extracted from stall flight data during multiple stall recovery maneuvers. As illustrated, a different lift path is modeled depending on the stall-recovery initial AOA, but the same lower, average recovery lift level (e.g., lift floor) is followed throughout the stall recovery maneuver starting at the AOA at which the recovery is initiated. However, this incremental effect is added to the simulation model only after AOA has exceeded a threshold or trigger AOA corresponding to that at the maximum lift coefficient, C_{Lmax}, (e.g., the stall AOA) and the AOA rate is negative, which is indicative of a recovery from a stall, or from an AOA beyond stall. In other words, the current modeling approach adjusts static lift by a stall hysteresis lift increment applied above a prescribed AOA, namely that at C_{Lmax} or beyond, but only if AOA is decreasing. As a result of this modeling approach, if the AOA approaches but never reaches the prescribed, trigger AOA at C_{Lmax}, a pre-stall recovery would follow the stall entry lift path, namely the static lift curve. In such cases, the stall hysteresis model is not activated even though the sign of the AOA rate indicates a recovery.

This is one example of the need for improvements in this particular known modeling approach because the hysteresis effect, which is still present because of the proximity to the stall AOA at the initiation of the near-stall recovery, is switched off based on the application logic of this component, thereby resulting in a significant lift error in the simulation. For instance, if AOA is increasing in a simulated stall and then reverses direction decreasing just prior to reaching the stall AOA, the simulation model lift follows the static lift curve as AOA decreases while actual flight test data suggest otherwise. For example, here are instances of lower lift levels in such early recovery maneuvers or AOA control hesitation in the stall entry maneuver as indicated by flight stall-recovery traces in FIG. 4.

Additionally, this type of modeling uses AOA rate only to determine the stall recovery lift path followed, and not to adjust the path itself. This is another example of the need for improvements in this particular known modeling approach, which in its present form results in the modeled stall recovery lift having a fixed lower level as opposed to the different levels exhibited by the flight data.

FIG. 6 illustrates the simulated lift with a stall hysteresis model structured as described in FIG. 5. The simulation model basic lift curve 400 includes an upper path (the static lift curve) that corresponds to the stall entry and a lower path that corresponds to the stall recovery. The lower path is calculated using the table of stall-hysteresis lift increments (e.g., the stall hysteresis lift correction term, or model component) to adjust the upper static lift curve only after the stall AOA has been exceed and the AOA rate is negative. However, in the stall recovery, there is still a significant variation in the actual flight-data paths or curves that is not reflected by the lower paths of the simulation curve 400 with the hysteresis effect applied as described above. As illustrated, even with the stall hysteresis correction to static lift, the known simulation curve 400 overcorrects some stall recoveries (e.g., where the lift is not as low as that modeled by the lower lift path of the simulation curve 400). As a result, the current models produce a positive lift error (i.e., the difference between the flight value and the simulation value) for those stall recoveries indicative of lower modeled lift than flight. Therefore, the existing flight simulation model does not substantially eliminate the lift error but, rather, redistributes it around a lower stall recovery lift level.

The stall hysteresis phenomenon experienced by commercial transports in flight test stalls is directly related to the dynamic reattachment of separated flow on the upper surface of the wing during the stall recovery maneuver. In a dynamic stall, rapidly increasing the AOA generates additional lift through the dynamic formation of a continuous spanwise vortex along the leading edge of the wing and the consequent delay in flow separation that is not experienced under static conditions across the stall angle-of-attack range. Because stall entry rates are controlled, dynamic stall seldom occurs in flight test and the stall is quasi-static. However, regardless of the type of stall entry, quasi-static or dynamic, once the wing stalls, flow reattachment is delayed if AOA decreases rapidly resulting in lower lift than the static or quasi-static case (e.g., during an atypical slow recovery, or a typical slow stall entry).

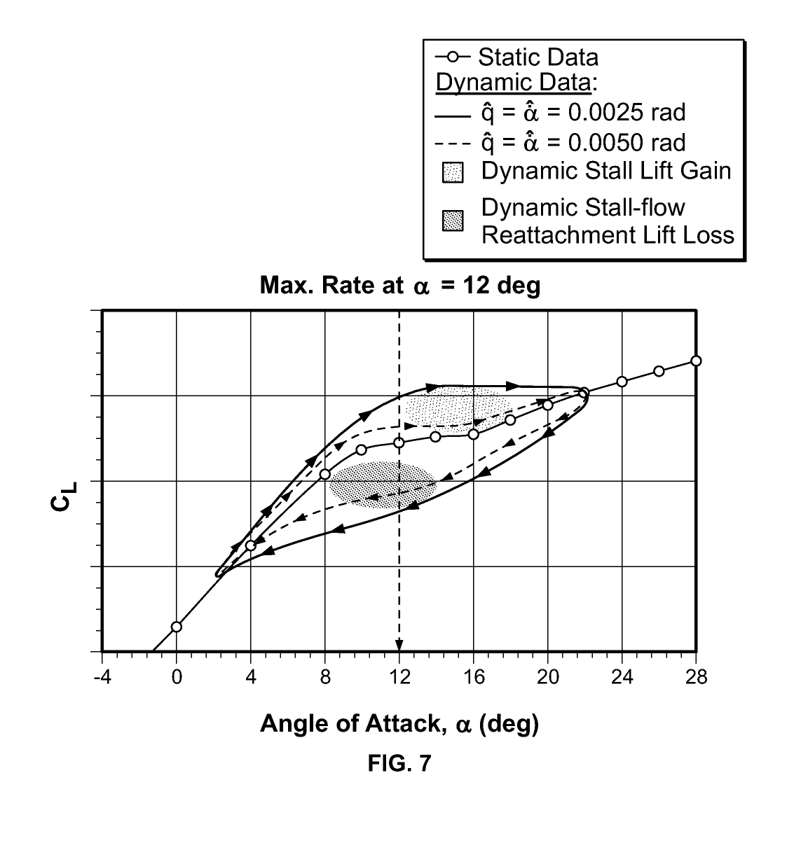

FIG. 7 illustrates both the dynamic stall and the dynamic stall-flow reattachment effect on lift using data from a plurality of static and dynamic wind tunnel tests with the same scale model of an aircraft. In the example from the static tests, the model was pitched through a relatively wide AOA range, pausing at specific points (as represented by the data points along the static data line) to allow the flow to stabilize before measuring the lift generated by the model. This was done in both directions to confirm the absence of static stall hysteresis effect near the stall AOA at approximately 12 degrees. In this example model configuration and test conditions (e.g., flaps up and low tunnel speed) lift does not reach a maximum at the stall, but the lift curve flattens with increasing AOA and then steepens again beyond the stall following the fully-separated-flow trend. The local flattening signals the onset of flow separation on the upper surface of the wing and the transition from ‘upper-and-lower’ to ‘mostly-lower’ surface wing lift without a well defined local maximum lift point as previously described. This, nonetheless, constitutes the stall region for this particular scale-model configuration.

In the two examples from the dynamic tests the model was pitched in an oscillatory motion at two different frequencies through the same 20-degree AOA range centered about the stall AOA at 12 degrees. The forced-oscillation test technique is such that both pitch rate and AOA rate are the same during the pitch-oscillation cycles. At the stall AOA the magnitude of the positive and negative rates reach a maximum, and at the pre- and post-stall extremes of the oscillation cycles, the rates are zero. A comparison of the dynamic lift loops generated during the oscillation cycle to the static lift data reveals higher dynamic stall lift at the maximum positive rate points and lower dynamic stall-flow-reattachment lift at the maximum negative-rate points. At the extremes of the oscillation cycles where the rates are zero, the dynamic lift roughly matches the lift curve from the static test. At the two different frequencies of oscillation, the dynamic lift gain and loss are related to the magnitude of the oscillation pitch or AOA rate (i.e., faster rates produce larger dynamic lift loops). A comparable set of dynamic loops across pre-stall angles of attack suggest a much smaller dynamic lift effect.

The plot in FIG. 7 shows the coefficient of lift, C_{L}, versus the AOA measured during one static test and two dynamic tests examples. In the static test the lift generated, static lift curve, is analogous that that in a slow stall entry. In the dynamic tests, the lift generated in the bottom half of the lift loops is analogous to that in two fast stall recovery maneuvers, one of them twice as fast as the other. The differences between the lift levels reached are analogous to some of the differences observed in the lift traces from the flight stall-recovery maneuvers in FIG. 4 and repeated in FIG. 6 where pilot recovery techniques and/or different pitch stability due to different flight center-of-gravity locations necessarily result in different stall-recovery rates and thus different stall-recovery lift traces.

The example flight simulation models disclosed herein can replace the known models to increase the fidelity (e.g., accuracy) of the model components when simulating flight in stall and stall recovery scenarios. The example flight simulation models use a dynamic model based on flight-test data that closely resembles the dynamic wind-tunnel data characteristics, such as those illustrated in FIG. 7. In other words, the example flight simulation models described herein may replace the known quasi-static, two-path, stall-entry/recovery hysteresis modeling approach, or the known pitch-rate modeling alternative described herein. The replacement example flight simulation models are nonlinear dynamic-derivative models, or incremental nonlinear dynamic models that capture the nonlinearities with AOA rate across a wide range of AOA through the stall as indicated by stall entry and recovery flight test data and any other applicable test data. As a result, the example flight simulation models described herein generate more accurate values for the model components (e.g., pitching moment, lift, drag, etc.) and, thus, increase the fidelity of flight simulation associated with aircraft stall aerodynamics. The example simulation models use a plurality of forced-oscillation or other dynamic wind-tunnel tests (e.g. curved-flow, pitch-plunge, random-motion, etc.) as a guide in shaping the nonlinearities (e.g., with the primary basis of these models being a plurality of flight-test stall data).

The example flight simulation models disclosed herein utilize AOA rate as an independent variable in model components affected by dynamic stall and dynamic stall-flow reattachment effects. As a result, the modeling of these effects is more accurate than known models because the physics that governs these effects are associated with AOA rate. Some known models use pitch rate (and not AOA rate), which introduces a simulation error in the modeled stall aerodynamics when pitch rate and AOA rate are different in an aerodynamic stall scenario.

The example flight simulation models disclosed herein utilize nonlinear dynamic derivative tables or dynamic increment tables for one or more of the model components such as lift, pitching moment and drag that are functions of both AOA and AOA rate (as well as other independent variables (e.g., flap deflection)). The example simulation models may replace known flight simulation models that use a stall hysteresis modeling approach that does not incorporate a variation with AOA rate, or that includes a variation with pitch rate alone, to more accurately simulate flight lift, pitching moment and/or drag, in either the stall entry or stall recovery maneuvers regardless of stall type, or the magnitude of the AOA rates experienced.

The dynamics of wing flow separation in the stall environment and/or the resulting wing-wake variations also may affect other model components in addition to or as an alternative to the lift, drag and pitching moment model components. As such, other example flight simulation model components can be more accurately modeled to include variations with AOA rate, as well as the other independent variables that are commonly included in these other model components. Following is a list of such example model components:

(1) Longitudinal dynamic stability model components, such as pitch due to pitch rate (e.g., pitch damping), that would be affected by wing-stall, flow dynamics due to AOA rate and the effect on the wing wake characteristics that in turn affects the horizontal stabilizer 106 (FIG. 1) (e.g., which is the primary contributor in the longitudinal dynamic stability component). In some examples, the companion lift and/or drag model components are also affected.

(2) Lateral/directional static stability model components such as roll due to sideslip (e.g., lateral stability) and yaw due to sideslip (e.g., directional stability), where the former is due to wing-stall flow dynamics and the latter is due to the effect of wing-stall flow dynamics on the wake, which in turn affects the contribution of the vertical stabilizer 108 (FIG. 1) in the lateral/directional static stability model component of the yaw component. In some examples, side force due to sideslip is affected (e.g., through the associated change in the wake effect on the vertical stabilizer 108).

(3) Lateral/directional dynamic stability model components such as roll due to roll rate (e.g., roll damping) and yaw due to yaw rate (e.g., yaw damping), which are similarly affected by wing-stall flow dynamics and the associated effect on the wing wake, respectively.

(4) The remaining lateral/directional dynamic stability model components, which include yaw coupling due to roll rate, roll coupling due to yaw rate and the two companion side-force components due to roll rate and yaw rate; the latter two being affected less by the wing-stall flow dynamics and more by the associated effect on the wake affecting the tail contribution in side force to the latter two components.

(5) The spoiler and aileron control effectiveness model components (e.g., primarily the roll component), which are affected by the wing-stall flow dynamics.

(6) The stabilizer and elevator control effectiveness model components (e.g., in the pitch component); and the rudder effectiveness model component (e.g., primarily in the yaw component). These control surfaces are affected by wing wake variations due to the wing stall dynamics.

(7) In more complex flight simulation models, all of the above components may be modeled as the sum of fuselage-and-wing model components and tail model components where the latter include wing downwash, sidewash and wake-energy effect components in the buildup terms of the tail model components (e.g., horizontal stabilizer increments, vertical stabilizer increments, and elevator and rudder control effectiveness increments). In such examples, the wing-stall flow dynamics effect on the tail components are indirectly incorporated through these three wake-effect model subcomponents.

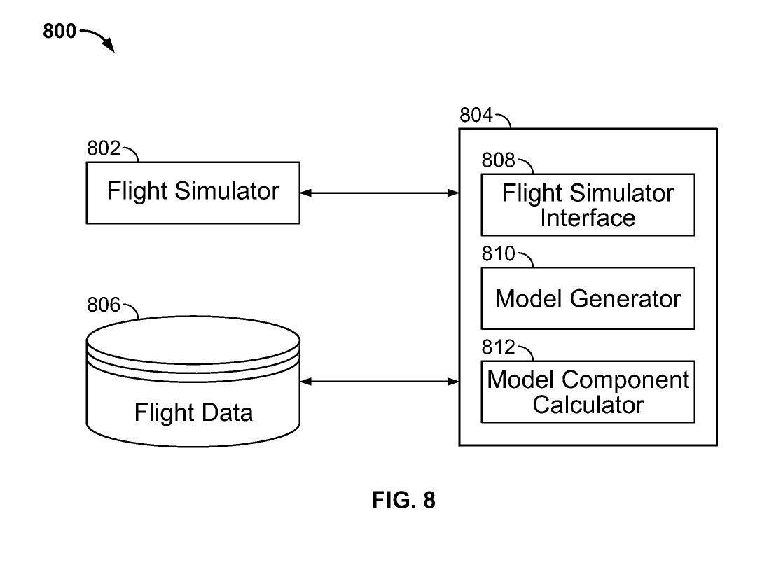

FIG. 8 illustrates an example flight modeling system 800 that is used for implementing the example flight simulation models described herein. The example system 800 includes a flight simulator 802, a modeler 804 and a flight data database 806. The flight simulator 802 may be any flight simulator and/or flight simulation program that simulates flight of an aircraft such as, for example, a cockpit procedures trainer (CPT), an aviation training device (ATD), a basic instrument training device (BITD), a flight and navigation procedures trainer (FNPT), an integrated procedures trainer (IPT), a flight training device (FTD), a full flight simulator (FFS), a full mission simulator (FMS) or any other flight simulation training device (FSTD). The flight simulator 802 may include one or more inputs (e.g., control column and wheel or a joy stick, pedals, control buttons, switches, levers, etc.), a display (e.g., a screen, instrument panel, etc.), and one or more outputs (e.g., parameters or visual motion displayed as behavior of the aircraft on the display, or data output for post-processing or analysis, etc.).

In the illustrated example, the modeler 804 monitors the behavior of the aircraft as simulated by the flight simulator 802. In the illustrated example, the modeler 804 includes a flight simulator interface 808 that receives and interprets commands and/or the aircraft behavior as simulated by the flight simulator 802.

To determine how aerodynamic characteristics affect an aircraft, the modeler 804 includes a model generator 810. The model generator 810 uses flight data stored in the flight data database 806. The flight data may be collected from full-scale, real aircraft flight tests, scale-model flight tests and/or static and dynamic wind tunnel tests. The flight data includes measurements (e.g., values) of the different model components as related to (e.g., depending on) the AOA rate and the corresponding AOA of the measurement (e.g., in a nonlinear dynamic-derivative or dynamic-incremental-effect table that is both a function of AOA and AOA rate and may be a function of other parameters as well). The flight data may include test data obtained or collected from test flights during various maneuvers over a range of dynamic content (e.g., quasi-static or dynamic stall entries in a wings-level stall, dynamic stall recoveries in a wings-level stall, quasi-static or dynamic stall entries in a turning stall, dynamic stall recovery in a turning stall, wind-up turn to stall, pull-up and push-over maneuvers near stall, etc.). For example, the flight data may be analyzed (e.g., via an empirical analysis tool such as force-and-moment coefficient extraction program, parameter identification program, etc.) to determine the dependency of each of the model components on AOA rate as an independent variable during the various maneuvers. The model components may include pitching moment, lift, drag, and/or any other model component affected by AOA rate in or near a dynamic stall/stall-recovery environment. These model components may be measured and correlated to the measured AOA and corresponding AOA rate during the stall entry and the stall recovery for both wings level stalls and turning stalls, and any other near-stall maneuver. In some examples, the model generator 810 analyzes the flight test data to derive the variation of the respective model components in relation to AOA rate at the corresponding AOA and other parameters that may also have an effect on the model component. In some examples, the derivation process is performed iteratively until the variation in model component values with AOA rate, and AOA and other parameters involved, converges so as to reduce the overall error between the simulated and flight measured parameter such as, for example, the error in flight lift. The derived model component variation as a function of AOA rate in addition to AOA and other parameters involved, such as flap deflection, define the multiplicity of dynamically different stall and stall recovery traces (e.g., paths, curves, etc.) of the model component in the flight test data. For example, the plurality of flight-stall lift “hysteresis” traces, as disclosed herein, reflect the change in values of the model components during relatively fast stall recovery as compared to the values during relatively slow stall entry.

To determine or calculate one or more values for the model components that are to affect the behavior of the simulated aircraft, the modeler 804 has a model component calculator 812. The calculator 812 receives the AOA rate information from the flight simulator interface 808, and determines value(s) for the various model components (e.g., pitching moment, lift, drag and/or any other aerodynamic model component(s) affected by the dynamics of wing stall and the associated effect on the wing wake) based on the flight-data derived curves or dynamic derivative or dynamic increment tables from the model generator 810. The flight simulator interface 808 may then transmit the determined value(s) of model components to the flight simulator 802. As a result, the flight simulator 802 can more accurately simulate the behavior of the aircraft during stall entry and stall recovery maneuvers. In some examples, the non-linear or dynamic stall modeling may be triggered when a threshold AOA and/or AOA rate is satisfied. For example, the disclosed techniques may be employed when the AOA has exceeded the trigger, near-stall or stall AOA.

In the illustrated example of FIG. 8 the flight simulator 802, the modeler 804 and flight data database 806 are depicted as separate from each other. However, in other examples, any of the flight simulator 802, the modeler 804 and/or flight data database 806 may be combined in any manner. The flight simulator 802, the modeler 804 and flight data database 806 may be implemented as software, firmware and/or hardware. In some examples, the flight data database 806 may be communicatively coupled to a network via which the flight data database 806 can be updated with additional flight test data.

While an example manner of implementing the flight modeling system 800 is illustrated in FIG. 8, one or more of the elements, processes and/or devices illustrated in FIG. 8 may be combined, divided, re-arranged, omitted, eliminated and/or implemented in any other way. Further, the example flight simulator 802, the example modeler 804, the example flight data database 806, the example flight simulator interface 808, the example model generator 810, the example model component calculator 812 and/or, more generally, the example flight modeling system 800 of FIG. 8 may be implemented by hardware, software, firmware and/or any combination of hardware, software and/or firmware. Thus, for example, any of the example flight simulator 802, the example modeler 804, the example flight data database 806, the example flight simulator interface 808, the example model generator 810, the example model component calculator 812 and/or, more generally, the example flight modeling system 800 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example flight simulator 802, the example modeler 804, the example flight data database 806, the example flight simulator interface 808, the example model generator 810 and/or the example model component calculator 812 is/are hereby expressly defined to include a tangible computer readable storage device or storage disk such as a memory, a digital versatile disk (DVD), a compact disk (CD), a Blu-ray disk, etc. storing the software and/or firmware. Further still, the example flight modeling system 800 of FIG. 8 may include one or more elements, processes and/or devices in addition to, or instead of, those illustrated in FIG. 8, and/or may include more than one of any or all of the illustrated elements, processes and devices.

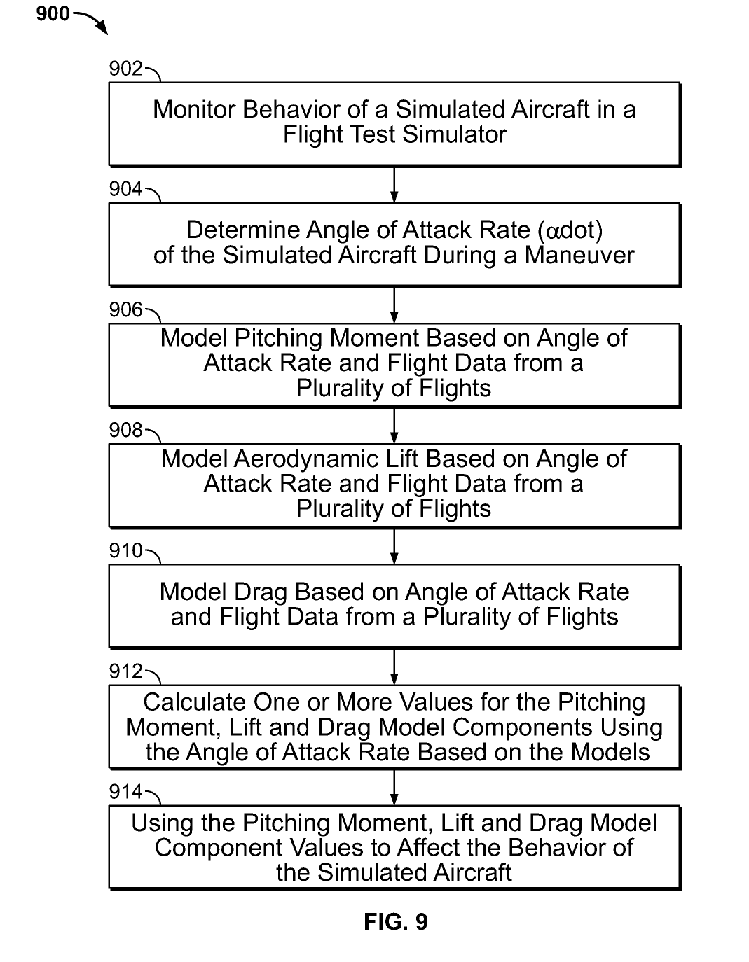

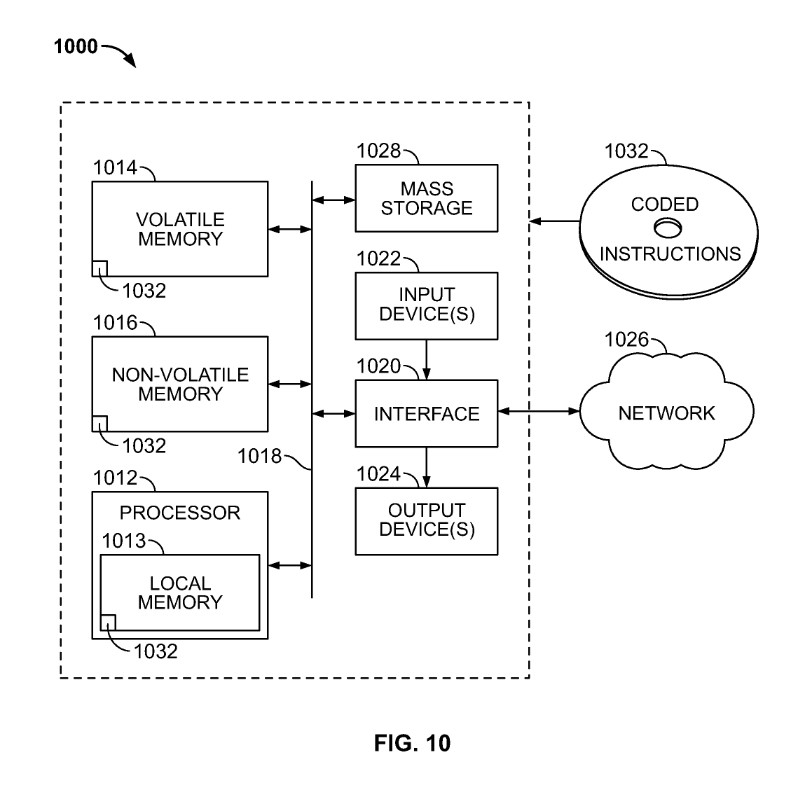

A flowchart representative of an example method for implementing the flight modeling system 800 is shown in FIG. 9. In this example, the method may be implemented using machine readable instructions that comprise a program for execution by a processor such as the processor 1012 shown in the example processor platform 1000 discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowchart illustrated in FIG. 9, many other methods of implementing the example flight modeling system 800 may alternatively be used. For example, the order of execution of the blocks may be changed, and/or some of the blocks described may be changed, eliminated, or combined.

As mentioned above, the example method of FIG. 9 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example method of FIG. 9 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example flowchart of FIG. 9 represents a method or process 900 for modeling the aerodynamic behavior of an aircraft during a stall. The example method 900 may be implemented to increase or enhance the fidelity of a flight simulation model, which may be used in a flight simulator and/or flight simulation program for training pilots and crew, for designing aircraft, for research, etc. In the illustrated example, the method 900 includes monitoring behavior of a simulated aircraft in a flight simulation (e.g., a flight simulator and/or a flight simulation program) (block 902). Flight simulators or flight simulation programs artificially recreate the aerodynamic behavior of a simulated aircraft based on various parameters (e.g., velocity, orientation of the aircraft relative to the direction of flight and its rate of change with time, rotational rates about the three orthogonal aircraft axes, actuation of the control surfaces, and high-lift and other devices that may affect the aerodynamics of the aircraft, etc.). For example, in the system 800 of FIG. 8, the modeler 804 monitors the behavior of a simulated aircraft from the flight simulator 802. The example modeler 804 may monitor different parameters associated with the behavior of the aircraft.

The example method 900 includes determining an AOA rate of the simulated aircraft during an operation or maneuver (block 904). In some examples, the operation or maneuver is a dynamic stall entry and/or a dynamic stall recovery maneuver. The dynamic entry and/or recovery stall maneuver may be either a wings level stall or a turning stall, for example. The AOA rate is a change in the AOA with respect to time. In the system 800 of FIG. 8, for example, the modeler 804 determines the AOA rate of the aircraft being simulated by the flight simulator 802 (e.g., based on the various inputs and/or parameters). The flight simulator 802 may employ one or more programs that simulate the flight of aircraft based on different parameters. The modeler 804 uses this information to determine an AOA rate exhibited by the aircraft.

The example method 900 includes modeling pitching moment, Cₘ, (e.g., a first model component) based on flight data from a plurality of flights (block 906), modeling lift, C_{L}, (e.g., a second model component) based on flight data from a plurality of flights (block 908) and modeling drag (e.g., a third model component) based on flight data from a plurality of flights (block 910). Each of these three longitudinal model components may be generated or derived by analyzing the flight data to determine a relationship of the respective model component to AOA rate. The flight data may be obtained or collected from test flights during various maneuvers (e.g., dynamic stall entry in a wings level stall, dynamic stall recover in a wings level stall, dynamic stall entry in a turning stall, dynamic stall recovery in a turning stall, etc.). In some examples, the flight data is collected from flight tests of the real, full-scale aircraft. Additionally or alternatively, the flight data may be collected from scale-model flight tests, static and dynamic wind tunnel tests or any combination thereof. The flight data is used to generate or derive longitudinal model components (e.g., a set of curves at different AOAs and flap deflections) for lift, pitching moment and drag varying with AOA rate in the flight data. Additionally or alternatively, one or more other model components may be generated or derived by analyzing the flight data to determine a relationship between the respective model component and the AOA rate. Other model components may include, for example, lateral/directional model components such as rolling moment, yawing moment and side force. In some examples, an empirical analysis program or tool is used to empirically determine the dynamic derivative, or dynamic increment based dependency of the various model components on the AOA rate (e.g., as an independent variable).

The example method 900 includes calculating or determining one or more values the pitching moment, lift and drag model components based on the respective models (as determined in blocks 906-910) (block 912) and using the determined AOA rate (as determined in block 904). In some examples, the one or more values for the model components are determined by comparing the determined AOA rate to the AOA rate of the curves generated by the models. In some examples, one or more dynamic derivative or dynamic increment tables are provided for each of the model components as a function of AOA rate (in addition to other parameters (e.g., AOA, sideslip angle, flap deflection, control surface deflection, rotational rates about the three aircraft axes, etc)), and the determined AOA rate may be analyzed against the tables to determine the one or more values for the model components that correspond to the AOA rate of the simulated aircraft and at the corresponding value(s) of the other independent variable(s) or parameter(s) (e.g., at a corresponding AOA). For example, in the system 800 of FIG. 8, the model component calculator 812 calculates the one or more values for the model component(s) based on the flight-derived data of the model generator 810.

The example method 900 includes using the pitching moment, the lift and/or the drag model component values to affect the longitudinal behavior of the simulated aircraft (block 914). In some examples, the lateral/directional behavior affected by rolling moment, yawing moment and/or side force are also used to affect the behavior of the simulated aircraft. For example, in the system 800 of FIG. 8, the flight simulator interface 808 uses the one or more values for the model component to simulate the aerodynamic behavior in the flight simulator 802.

In the example method 900, three model components are determined and used to simulate an aerodynamic affect on the simulated aircraft during a stall maneuver. However, in other examples, only one model component may be determined and used. In other examples, other model components may be used, such as roll due to sideslip (e.g., lateral stability), roll due to roll rate (e.g., roll damping), yaw coupling due to roll rate, roll coupling due to yaw rate and yaw due to yaw rate (yaw damping), aileron and spoiler roll control, stabilizer pitch control, wing downwash, wing-wake effect on tail surfaces (e.g., horizontal stabilizer increments, vertical stabilizer increments), other spoiler and aileron effectiveness increments (e.g., yawing moment and pitching moment increments, etc.) as well as rudder effectiveness increments such as, for example, the rudder yawing moment increment.

FIG. 10 is a block diagram of an example processor platform 1000 capable of executing instructions to implement the method 900 of FIG. 9 and the example flight modeling system 800 of FIG. 8. The processor platform 1000 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

Coded instructions 1032 to implement the method 900 of FIG. 9 may be stored in the mass storage device 1028, in the volatile memory 1014, in the non-volatile memory 1016, and/or on a removable tangible computer readable storage medium such as a CD or DVD.

From the foregoing, it will be appreciated that the above disclosed flight simulation models increase or enhance the fidelity of various model components by using AOA rate. In the example flight simulation models disclosed herein, the various models are generated by compiling flight data from a plurality of flight tests and deriving models by using the AOA rate as in independent variable in the model components. Using AOA rate is more accurate in accounting for dynamic stall and dynamic stall-flow reattachment effects that occur in stall entry and stall recovery maneuver, in either wings-level stalls and turning stalls or any other near-stall maneuver.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
monitoring, via a processor, a behavior of a simulated aircraft in a flight simulation;
determining, via the processor, an angle-of-attack (AOA) rate of the aircraft during a simulated dynamic stall maneuver;
determining, via the processor, a first value for a first model component based on the determined AOA rate; and
simulating, via the flight simulation, a first aerodynamic effect on the behavior of the aircraft during the simulated dynamic stall maneuver based on the first value of the first model component.

2. The method of claim 1, wherein determining the first value for the first model component includes:
collecting flight data from a plurality of test flights, the flight data including values of the first model component of the test flights based on AOA rates for the respective test flights;
generating a model of the first model component for the test flights as dependent on the AOA rates for the test flights; and
using the generated model to determine the first value for the first model component of the simulated aircraft at the determined AOA rate.

3. The method of claim 2, wherein the flight data is collected from at least one of a full-scale, real aircraft flight test, a scale-model flight test, or a static and dynamic wind-tunnel test.

4. The method of claim 1, wherein the first model component is a pitching moment component of the aircraft, lift component of the aircraft or drag component of the aircraft.

5. The method of claim 1 further comprising:
determining, via the processor, a second value for a second model component based on the determined AOA rate; and
simulating, via the flight simulation, a second aerodynamic effect on the behavior of the aircraft during the simulated dynamic stall recovery maneuver based on the second value of the second model component.

6. The method of claim 1, wherein the simulated dynamic stall recovery maneuver is associated with a turning stall.

7. The method of claim 1, wherein the determined AOA rate is different than a pitch rate of the simulated aircraft.

8. The method of claim 1, wherein the AOA rate is determined at a corresponding AOA, and the first value for the first model component is determined for the corresponding AOA.

9. The method of claim 1, wherein the dynamic stall maneuver is at least one of a stall entry or a stall recovery maneuver.

10. A system comprising:
a flight simulator to simulate an aircraft and a behavior of the aircraft during a dynamic stall maneuver; and
a processor to:
determine an angle-of-attack (AOA) rate of the simulated aircraft during the dynamic stall maneuver;
determine a first value for a first model component based on the determined AOA rate; and
input the first value for the first model component into the flight simulator to simulate a first aerodynamic effect on the behavior of the aircraft during the dynamic stall maneuver.

11. The system of claim 10 further including a database containing flight data from a plurality of test flights, the flight data comprising values of the first model component of the test flights based on AOA rates for the respective test flights, wherein the processor is to:
generate a model of the first model component of the test flights as dependent on the AOA rates for the test flights; and
determine the first value for the first model component of the simulated aircraft based on the generated model and the determined AOA rate.

12. The system of claim 11, wherein the flight data is from at least one of a full-scale, real aircraft flight test, a scale-model flight test, or a static and dynamic wind-tunnel test.

13. The system of claim 10, wherein the first model component is a pitching moment component of the aircraft, lift component of the aircraft or drag component of the aircraft.

14. The system of claim 10, wherein the processor is to:
determine a second value for a second model component based on the determined AOA rate; and
input the second value for the second model component into the flight simulator to simulate a second aerodynamic effect on the behavior of the aircraft during the dynamic stall maneuver.

15. The system of claim 10, wherein the dynamic stall maneuver is associated with a turning stall.

16. The system of claim 10, wherein the determined AOA rate is different than a pitch rate of the simulated aircraft.

17. A tangible machine readable storage medium comprising instructions that, when executed, cause a machine to at least:
monitor a behavior of a simulated aircraft in a flight simulation;
determine an angle-of-attack (AOA) rate of the simulated aircraft during a simulated dynamic stall maneuver;
determine a first value of a first model component based on the determined AOA rate; and
simulate a first aerodynamic effect on the behavior of the aircraft during the simulated dynamic stall maneuver based on the first value of the first model component.

18. The tangible machine readable storage medium of claim 17, wherein the instructions, when executed, further cause the machine to:
collect flight data from a plurality of test flights, the flight data including values of the first model component of the test flights based on AOA rates for the respective test flights;
generate a model of the first model component of the test flights as dependent on the AOA rates of the test flights; and
determine the first value for the first model component of the simulated aircraft based on the generated model and the determined AOA rate.

19. The tangible machine readable storage medium of claim 18, wherein the flight data is collected from at least one of a full-scale, real aircraft flight test, a scale-model flight test, or a static and dynamic wind-tunnel test.

20. The tangible machine readable storage medium of claim 17, wherein the first model component is a pitching moment component of the aircraft, lift component of the aircraft or drag component of the aircraft.

21. The tangible machine readable storage medium of claim 17, wherein the instructions, when executed, further cause the machine to:
determine a second value for a second model component based on the determined AOA rate; and
simulate a second aerodynamic effect on the behavior of the aircraft during the simulated dynamic stall maneuver based on the second value of the second model component.

22. The tangible machine readable storage medium of claim 17, wherein the simulated dynamic stall recovery maneuver is associated with a turning stall.
